(19) United States
(12) Patent Application Publication
(10) Pub. No.: US 2023/0262549 A1
(43) Pub. Date: Aug. 17, 2023

(54) METHOD AND APPARATUS FOR UE CAPABILITY SIGNALING FOR CONDITIONAL PSCELL CHANGE IN WIRELESS COMMUNICATION SYSTEM

(71) Applicant: Samsung Electronics Co., Ltd., Suwon-si (KR)

(72) Inventor: June HWANG, Suwon-si (KR)

(21) Appl. No.: 18/169,760

(22) Filed: Feb. 15, 2023

(30) Foreign Application Priority Data
Feb. 17, 2022 (KR) 10-2022-0020721

(51) Int. Cl. H04W 36/00; H04W 8/22

(52) U.S. Cl. CPC H04W 36/00837; H04W 8/22

(57) ABSTRACT

The disclosure relates to a 5th generation (5G) or 6th generation (6G) communication system for supporting a higher data transmission rate. A method performed by a first base station in a wireless communication system is provided. The method incudes transmitting, to a second base station, a secondary node addition request message including information regarding a number of conditional reconfiguration allowed to the second base station, and receiving, from the second base station, a secondary node addition request acknowledge message, wherein the information regarding the number of conditional reconfiguration allowed to the second base station is used to provide configuration information for a condition reconfiguration between a user equipment (UE) and the second base station.

### CROSS-REFERENCE TO RELATED APPLICATION

This application is based on and claims priority under 35 U.S.C. § 119 to Korean Patent Application No. 10-2022-0020721, filed on Feb. 17, 2022, in the Korean Intellectual Property Office, the disclosure of which is herein incorporated by reference in its entirety.

### BACKGROUND

### 1. Field

The disclosure relates to cell change in a wireless communication system, and more particularly, to a method and an apparatus for conditional primary-secondary cell (PSCell) change.

### 2. Description of Related Art

5th generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement 6th generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Embodiments of the disclosure provide an apparatus and a method for effectively providing a service in a mobile communication system.

In accordance with an aspect of the disclosure, a method performed by a first base station in a wireless communication system is provided. The method includes transmitting, to a second base station, a secondary node addition request message including information regarding a number of conditional reconfiguration allowed to the second base station, and receiving, from the second base station, a secondary node addition request acknowledge message, wherein the information regarding the number of conditional reconfiguration allowed to the second base station is used to provide configuration information for a condition reconfiguration between a user equipment (UE) and the second base station.

The information regarding the number of conditional reconfiguration includes information regarding a number of conditional reconfiguration for a secondary node initiated conditional primary secondary cell (PSCell) change (SI-CPC).

The information regarding the number of conditional reconfiguration is included in a radio resource control (RRC) container in the secondary node addition request message.

The method further includes transmitting, to the UE, a UE capability enquiry message; and receiving, from the UE, a UE capability information message including capability information related to the conditional reconfiguration.

The method further includes transmitting, to the UE, an RRC reconfiguration message to configure at least one conditional reconfiguration, wherein each of the at least one conditional reconfiguration is for at least one of a conditional handover, a CPC, a conditional PSCell addition (CPA).

In accordance with an aspect of the disclosure, a method performed by a second base station in a wireless communication system is provided. The method includes receiving, from a first base station, a secondary node addition request message including information regarding a number of conditional reconfiguration allowed to the second base station, transmitting, to the first base station, a secondary node addition request acknowledge message, and performing a configuration procedure with a user equipment (UE) based on a number of conditional reconfiguration allowed to the second base station.

The information regarding the number of conditional reconfiguration includes information regarding a number of conditional reconfiguration for a secondary node initiated conditional primary secondary cell (PSCell) change (SI-CPC).

The information regarding the number of conditional reconfiguration is included in a radio resource control (RRC) container in the secondary node addition request message.

The performing of the configuration procedure with the UE comprises transmitting, to the UE, an RRC reconfiguration message to configure at least one conditional reconfiguration.

The each of at least one conditional reconfiguration is for at least one of a conditional handover, a CPC, a conditional PSCell addition (CPA).

In accordance with another aspect of the disclosure, a first base station in a wireless communication system is provided. The first base station includes at least one transceiver, and at least one processor operatively coupled with the at least one transceiver, wherein the at least one processor is configured to transmit, to a second base station, a secondary node addition request message including information regarding a number of conditional reconfiguration allowed to the second base station, and receive, from the second base station, a secondary node addition request acknowledge message, wherein the information regarding the number of conditional reconfiguration allowed to the second base station is used to provide configuration information for a condition reconfiguration between a user equipment (UE) and the second base station.

The information regarding the number of conditional reconfiguration includes information regarding a number of conditional reconfiguration for a secondary node initiated conditional primary secondary cell (PSCell) change (SI-CPC).

The information regarding the number of conditional reconfiguration is included in a radio resource control (RRC) container in the secondary node addition request message.

The at least one processor is further configured to transmit, to the UE, a UE capability enquiry message, and receive, from the UE, a UE capability information message including capability information related to the conditional reconfiguration.

The at least one processor is further configured to transmit, to the UE, an RRC reconfiguration message to configure at least one conditional reconfiguration, wherein each of the at least one conditional reconfiguration is for at least one of a conditional handover, a CPC, a conditional PSCell addition (CPA).

In accordance with another aspect of the disclosure, a second base station in a wireless communication system is provided. The second base station includes at least one transceiver; and at least one processor operatively coupled with the at least one transceiver, wherein the at least one processor is configured to receive, from a first base station, a secondary node addition request message including information regarding a number of conditional reconfiguration allowed to the second base station, transmit, to the first base station, a secondary node addition request acknowledge message, and perform a configuration procedure with a user equipment (UE) based on the a number of conditional reconfiguration allowed to the second base station.

The information regarding the number of conditional reconfiguration includes information regarding a number of conditional reconfiguration for a secondary node initiated conditional primary secondary cell (PSCell) change (SI-CPC).

The information regarding the number of conditional reconfiguration is included in a radio resource control (RRC) container in the secondary node addition request message.

The at least one processor is further configured to transmit, to the UE, an RRC reconfiguration message to configure at least one conditional reconfiguration.

The each of at least one conditional reconfiguration is for at least one of a conditional handover, a CPC, a conditional PSCell addition (CPA).

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of LTE system according to an embodiment of the present disclosure;

FIG. 2 illustrates a wireless protocol structure of the LTE system according to an embodiment of the present disclosure;

FIG. 3 illustrates a structure of a next-generation mobile communication system according to an embodiment of the present disclosure;

FIG. 4 illustrates a wireless protocol structure of the next-generation mobile communication system according to an embodiment of the present disclosure;

FIG. 5 illustrates an inner structure of a terminal according to an embodiment of the present disclosure;

FIG. 6 illustrates a configuration of a new radio (NR) base station according to an embodiment of the present disclosure; and

FIG. 7 illustrates an inter-node signal system in which an MN receiving UE capability information from UE delivers information, to an SN, regarding a maximum number of conditional reconfigurations allowed to the SN according to an embodiment of the present disclosure.

### DETAILED DESCRIPTION

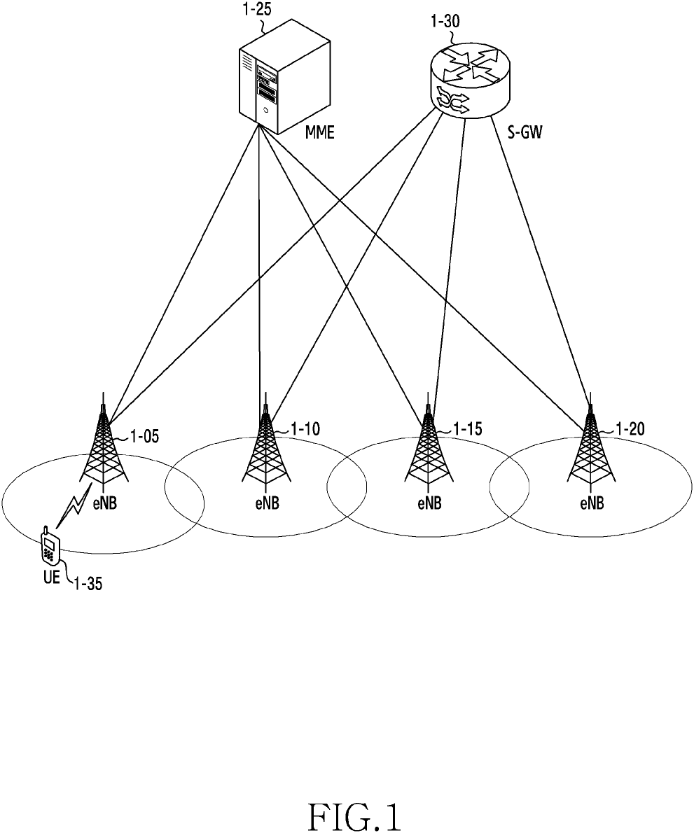

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, an operating principle of the disclosure will be described with reference to the accompanying drawings. In describing the disclosure, detailed descriptions of well-known functions or configurations will be omitted since they would unnecessarily obscure the subject matters of the disclosure. Also, the terms used herein are defined according to the functions of the disclosure. Thus, the terms may vary depending on users’ or operators’ intentions or practices. Therefore, the terms used herein should be understood based on the descriptions made herein.

The advantages and features of the disclosure, and methods for achieving the same will be apparent by referring to embodiments, which will be described below in detail along with the accompanying drawings. However, the disclosure is not limited to embodiments disclosed hereinbelow, and may be embodied in many different forms. Embodiments disclosed hereinbelow are provided only to make the disclosure thorough and complete and fully convey the scope of the disclosure to those of ordinary skill in the art, and the disclosure may be defined only by the scope of the appended claims. Throughout the specification, the same reference numerals indicate the same components.

It will be understood that each block of the process flowcharts described hereinbelow and combinations of the flowcharts may be performed by computer program instructions. These computer program instructions may be loaded into a processor of a generic-purpose computer, a special computer, or other programmable data processing equipment. The instructions performed by the processor of the computer or other programmable data processing equipment may generate a means for performing functions explained in the block(s) of the flowcharts. The computer program instructions may be stored in a computer usable or computer readable memory which is directed at a computer or other programmable data processing equipment in order to implement a function in a specific method. Accordingly, the instructions stored in the computer usable or computer readable memory may produce a manufacturing item including an instruction means for performing functions explained in the block(s) of the flowcharts. The computer program instructions may be loaded on a computer or other programmable data processing equipment. Accordingly, a series of operation steps may be performed on the computer or other programmable data processing equipment to generate a process to be executed by the computer, and the instructions performing the computer or other programmable data processing equipment may provide steps for executing functions explained in the block(s) of the flowcharts.

In addition, each block may indicate a part of a module, a segment or a code including one or more executable instructions for executing a specified logical function(s). It should be noted that in some alternative examples, functions mentioned in blocks may be generated irrespective of an order. For example, two blocks which are successively illustrated may be performed substantially at the same time, or may be performed in the inverse order according to their corresponding functions.

The term “unit” used in the present embodiments refers to a software component or a hardware component such as a field programmable gate array (FPGA) or an application specific integrated circuit (ASIC), and the “unit” performs a certain role. However, the “unit” is not limited to software or hardware, The “unit” may be configured to exist in a storage medium which may address, and may be configured to reproduce one or more processors. For example, the “unit” may include components such as software components, object-oriented software components, class components and task components, and processes, functions, attributes, procedures, sub-routines, segments of a program code, drivers, firmware, microcode, circuit, data, database, data structures, tables, arrays, and variables. Functions provided in the components and the “units” may be coupled with fewer components and “units” or may further be divided into additional components and “units.” In addition, the components and the “units” may be implemented to reproduce one or more CPUs in a device or a security multimedia card. In addition, in an embodiment, the “unit” may include one or more processors.

As used herein, a term for identifying an access node, terms indicating network entities, terms indicating messages, a term indicating an interface between network entities, terms indicating a variety of identification information are merely examples for the convenience of explanation. Accordingly, the disclosure is not limited to terms described below, and other terms having the same technical meanings may be used to indicate these objects.

In the disclosure, terms and names defined in 3rd generation partnership project long term evolution (3GPP LTE) are used for the convenience of explanation. However, the disclosure is not limited by these terms and names, and the same may be equally applied to systems conforming to other standards.

A base station which will be described hereinbelow refers to an entity that performs resource allocations of a terminal, and may be at least one of a gNode B, an eNode B, a Node B, a base station (BS), a radio access unit, a base station controller, or a node over a network. A terminal may include user equipment (UE), a mobile station (MS), a cellular phone, a smartphone, a computer, or a multimedia system performing a communication function. Of course, the disclosure is not limited to the above-described examples.

In particular, the disclosure may be applied to 3GPP NR (e.g., 5th generation mobile communication standards). In addition, the disclosure may be applied to intelligent services (for example, a smart home, a smart building, a smart city, a smart car or connected car, health care, digital education, retail business, a security and safety-related service, etc.) which is based on 5G communication technology and IoT-related technology. In the disclosure, eNB may be interchangeably used with gNB. That is, a base station explained as eNB may indicate gNB. In addition, the term “terminal” may indicate not only a mobile phone, NB-IoT devices, sensors, but also other wireless communication devices.

Beyond the initial function of providing a voice-oriented service, a wireless communication system is developing into a broadband wireless communication system which provides a packet data service of high-speed, high quality like communication standards, such as high speed packet access (HSPA) of 3GPP, long term evolution (LTE) or evolved universal terrestrial radio access (E-UTRA), LTE-Advanced (LTE-A), LTE-Pro, high rate packet data of 3GPP2, ultra mobile broadband (UWB), and 802.16e of IEEE.

In an LTE system, which is a representative example of the broadband wireless communication system, an orthogonal frequency division multiplexing (OFDM) scheme may be employed in a downlink (DL), and a single carrier-frequency division multiple access (SC-FDMA) scheme may be employed in an uplink (UL). The uplink refers to a wireless link through which a terminal (user equipment (UE) or a mobile station (MS)) transmits data or a control signal to a base station (eNode B or a base station (BS)), and the downlink refers to a wireless link through which a base station transmits data or a control signal to a terminal. In addition, the above-described multiple access schemes assign or manage time-frequency resources for carrying and transmitting data or control information for each user not to overlap one another, that is, to establish orthogonality, and thereby distinguish data or control information of each user.

A 5G communication system which is a post-LTE communication system should support a service satisfying various requirements simultaneously so as to freely reflect various requirements of a user and a service provider. Services which are considered for the 5G communication system may include enhanced mobile broadband (eMBB), massive machine type communication (mMTC), ultra-reliability low latency communication (URLLC).

According to some embodiments, the eMBB aims at providing a high data transmission speed which is more enhanced in comparison to a data transmission speed supported by existing LTE, LTE-A, or LTE-Pro. For example, in the 5G communication system, the eMBB should be able to provide a peak data rate of 20 Gbps in a downlink and to provide a peak data rate of 10 Gbps in an uplink from the point of view of one base station. In addition, the 5G communication system should provide an increased user perceived data rate of a terminal, while providing the peak data rate. In order to meet the requirements described above, there may be a demand for enhancement of various transmission and reception technologies including an enhanced multi input multi output (MIMO) transmission technology. In an LTE system, signals are transmitted by using a maximum transmission bandwidth of 20 MHz in a 20 GHz band, whereas in the 5G communication system, a frequency bandwidth larger than 20 MHz is used in a frequency band of 3-6 GHz or 6 GHz or more, so that the data transmission rate required in the 5G communication system may be satisfied.

At the same time, the mMTC may be considered in order to support an application service such as Internet of thing (IoT) in the 5G communication system. The mMTC may require support of access by massive terminals within a cell, enhanced coverage of a terminal, an increased battery time, reduction of a cost of a terminal in order to provide IoT efficiently. Since the IoT is attached to various sensors and various devices to provide a communication function, the IoT should be able to support many terminals (for example, 1,000,000 terminals/km2) within a cell. Since terminals supporting mMTC are likely to be positioned in a shaded area that is not covered by a cell, such as a basement of a building, due to characteristics of a service, a broader coverage may be required in comparison to other services provided by the 5G communication system. Since terminals supporting mMTC should be configured with low-priced terminals, and there may be difficulty in replacing a battery of a terminal frequently, there may be a need for a long battery lifetime, for example, a battery life of 10-15 years.

Lastly, the URLLC is a cellular-based wireless communication service which is used for a specific purpose (mission-critical), and may be used for services used for remote control of a robot or a machinery, industrial automation, an unmanned aerial vehicle, remote health care, an emergency alert. Accordingly, communication provided by the URLLC should provide very low latency and very high reliability. For example, services supporting the URLLC should satisfy air interface latency shorter than 0.5 millisecond, and simultaneously, should satisfy requirements of a packet error rate lower than or equal to 10-5. Accordingly, the 5G system should provide a shorter transmit time interval (TTI) than those of other services in order to provide a service supporting the URLLC, and simultaneously, should allocate broad resources in a frequency band in order to guarantee reliability of a communication link.

The three services considered in the 5G communication system, that is, eMBB, URLLC, mMTC, may be multiplexed in one system and may be transmitted. In this case, different transmission and reception techniques and transmission and reception parameters may be used between services in order to meet the different requirements of the respective service. However, the above-described mMTC, URLLC, eMBB are just different types of services, and a service type to which the disclosure is applicable is not limited to the above-described examples.

In the following descriptions, embodiments of the disclosure will be described by referring to LTE, LTE-A, LTE Pro or 5G (or NR, next-generation mobile communication) systems by way of an example, but embodiments of the disclosure may be applied to other communication systems having similar technical background or channel types. In addition, embodiments of the disclosure may be applied to other communication systems through some modification within the scope without departing from the scope of the disclosure, based on determination of a person skilled in the art.

The disclosure provides a method whereby a master node (MN) receiving a capability signal related to a conditional reconfiguration from a terminal negotiates with a secondary node (SN) about a conditional reconfiguration usable capability, to prevent a total amount of conditional configurations of the two nodes from exceeding a capability of the terminal. In addition, the disclosure provides a method for performing a conditional reconfiguration between a terminal and nodes with a secondary cell group (SCG) in a deactivation state.

According to disclosed embodiments, two nodes exchange capability information received from a terminal with each other through signals, and may negotiate with each other about the number of conditional reconfigurations required between the two nodes. In the disclosed embodiments, there is provided a method for operating independently without exceeding a maximum capability of a terminal when two independent nodes configure and command their respective conditional reconfigurations. In addition, the embodiments of the disclosure may prevent unnecessary inter-node signaling caused by performance of conditional reconfiguration within a secondary cell group in a deactivation state.

FIG. 1 illustrates a structure of an LTE system according to an embodiment of the present disclosure.

Referring to FIG. 1, a radio access network of the LTE system may include next-generation base stations (e.g., evolved Node B, hereinafter, eNB, node B, or base station) 1-05, 1-10, 1-15 1-20, a mobility management entity (MME) 1-25, and a serving-gateway (S-GW) 1-30. A user terminal (user equipment, hereinafter, UE or terminal) 1-35 may connect to an external network through the eNBs 1-05 to 1-20 and the S-GW 1-30.

In FIG. 1, the eNB 1-05 to 1-20 may correspond to an existing node B (Node B) in a universal mobile telecommunication system (UMTS). The eNB 1-05 to 1-20 may be connected with the UE 1-35 through a wireless channel, and may perform more complicated roles than the existing node B. In the LTE system, all user traffic including a real-time service such as voice over IP (VoIP), which is based on an Internet protocol, may be serviced through a shared channel. Accordingly, there is a need for a device that collects state information like a buffer state of UE, an available transmission power state, a channel state, and schedules, and the eNB 1-05 to 1-20 may be in charge of this role. One eNB may typically control a plurality of cells.

In addition, in order to implement a transmission speed of 100 Mbps, the LTE system may use orthogonal frequency division multiplexing (OFDM) in a 20 MHz bandwidth as a radio access technology. Of course, the disclosure is not limited to the above-described examples. In addition, the eNB 1a-05 to 1a-20 may apply an adaptive modulation and coding (AMC) scheme to determine a modulation scheme and a channel coding rate according to a channel state of the terminal. The S-GW 1-30 may be a device that provides a data bearer, and may create or remove a data bearer under the control of the MME 1-25. The MME may be a device that is in charge of a mobility management function for the terminal and various control functions, and may be connected with the plurality of base stations.

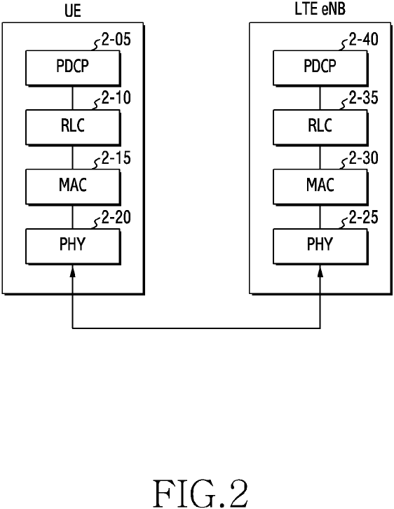

FIG. 2 illustrates a wireless protocol structure of the LTE system according to an embodiment of the present disclosure.

Referring to FIG. 2, the wireless protocol of the LTE system may include, in the terminal and the eNB, a packet data convergence protocol (PDCP) 2-05, 2-40, a radio link control (RLC) 2-10, 2-35, a medium access control (MAC) 2-15, 2-30, and a physical layer 2-20, 2-25, respectively. Of course, the wireless protocol of the LTE system may include more or less layers than those illustrated in FIG. 2.

According to an embodiment of the disclosure, the PDCP may be in charge of an operation like IP header compressing/decompression. Primary functions of the PDCP may be summarized as follows. Of course, the present disclosure is not limited to the following examples:
-Header compression and decompression: robust header compression (ROHC) only;
-Transfer of user data;
-In-sequence delivery of upper layer PDUs at PDCP re-establishment procedure for RLC acknowledge mode (AM);
-Reordering (e.g., for split bearers in DC (only support for RLC AM): PDCP PDU routing for transmission and PDCP PDU reordering for reception);
-Duplicate detection of lower layer SDUs at PDCP re-establishment procedure for RLC AM;
-Retransmission of PDCP SDUs at handover and, for split bearers in DC, of PDCP PDUs at PDCP data-recovery procedure, for RLC AM;
-Ciphering and deciphering; and/or
-Timer-based SDU discard in uplink.

According to an embodiment of the disclosure, the RLC 2-10, 2-35 may reconstruct a PDCP packet data unit (PDU) of an appropriate size, thereby performing an ARQ operation. Primary functions of the RLC may be summarized as follows. Of course, the present disclosure is not limited to the following examples:
-Transfer of upper layer PDUs;
-Error correction through ARQ (only for AM data transfer);
-Concatenation, segmentation and reassembly of RLC SDUs (only for UM and AM data transfer);
-Re-segmentation of RLC data PDUs (only for AM data transfer);
-Reordering of RLC data PDUs (only for UM and AM data transfer);
-Duplicate detection (only for UM and AM data transfer);
-Protocol error detection (only for AM data transfer);
-RLC SDU discard (only for UM and AM data transfer); and/or
-RLC re-establishment.

According to an embodiment, the MAC 2-15, 2-30 may be connected with various RLC layer devices constructed in one terminal, and may perform an operation of multiplexing the RLC PDUs into the MAC PDUs and demultiplexing the RLC PDUs from the MAC PDUs. Primary functions of the MAC may be summarized as follows. Of course, the present disclosure is not limited to the following examples:
-Mapping between logical channels and transport channels;
-Multiplexing/demultiplexing of MAC SDUs belonging to one or different logical channels into/from transport blocks (TB) delivered to/from the physical layer on transport channels;
-Scheduling information reporting;
-Error correction through HARQ;
-Priority handling between logical channels of one UE;
-Priority handling between UEs by means of dynamic scheduling;
-MBMS service identification;
-Transport format selection; and/or
-Padding.

According to an embodiment of the disclosure, the physical layer 2-20, 2-25 may perform an operation of channel coding and modulating upper layer data, making an OFDM symbol and transmitting via a wireless channel, or an operation of demodulating an OFDM symbol received through a wireless channel, channel decoding, and delivering to an upper layer. Of course, the disclosure is not limited to the above-described examples.

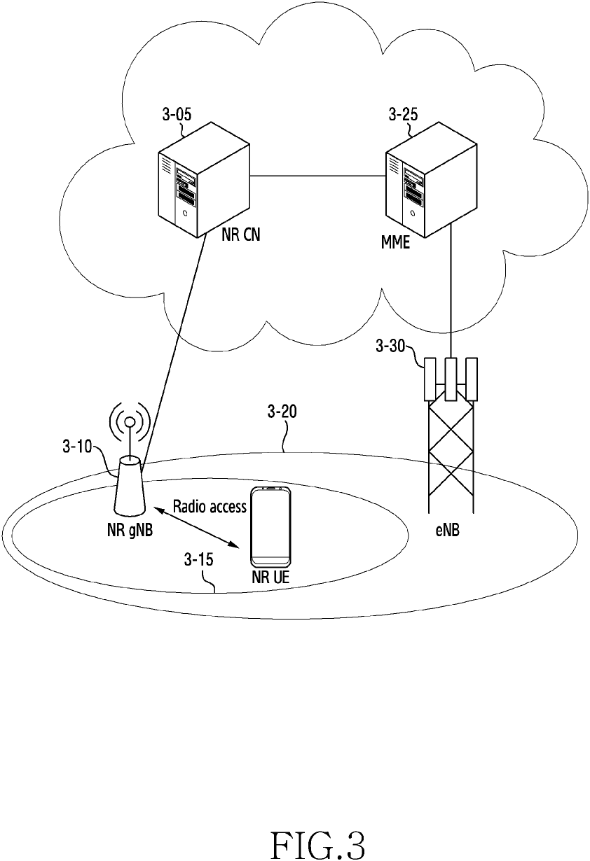

FIG. 3 illustrates a structure of a next-generation mobile communication system according to an embodiment of the present disclosure.

Referring to FIG. 3, a radio access network of a wireless communication system (hereinafter, a next-generation mobile communication system or NR or 5G) may include a next-generation base stations (new radio node B, hereinafter, NR gNB or NR base station) 3-10 and a next-generation radio core network (new radio core network (NR-CN)) 3-05. A next-generation radio user terminal (new radio user equipment (NR UE) or terminal) 3-15 may connect to an external network through the NR gNB 3-10 and the NR CN 3-05.

In FIG. 3, the NR gNB 3-10 may correspond to an evolved node B (eNB) of an existing LTE system. The NR gNB 3-10 may be connected with the NR UE 3-15 through a wireless channel, and may provide a more excellent service than the existing node B. In the next-generation mobile communication system, all user traffic may be serviced through a shared channel. Accordingly, there is a need for a device that collects state information like a buffer state of UEs, an available transmission power state, a channel state, and schedules, and the NR gNB 3-10 may be in charge of this role. One NR gNB may control a plurality of cells.

According to an embodiment, in order to implement a superhigh transmission speed compared to a current LET system, the next-generation mobile communication system may apply a bandwidth larger than or equal to a current maximum bandwidth. In addition, a beamforming technology may be used by using OFDM as a radio access technology.

In addition, according to an embodiment, an AMC scheme may be applied to determine a modulation scheme and a channel coding rate according to a channel state of a terminal. The NR CN 3-05 may perform functions of supporting mobility, configuring a bearer, and configurating quality of service (QoS). The NR CN 3-05 may be a device that is in charge of a mobility management function for the terminal and various control functions, and may be connected with a plurality of base stations. In addition, the next-generation mobile communication system may interlock with an existing LTE system, and the NR CN 3-05 may be connected with an MME 3-25 through a network interface. The MME 3-25 may be connected with an eNB 3-30 which is an existing base station.

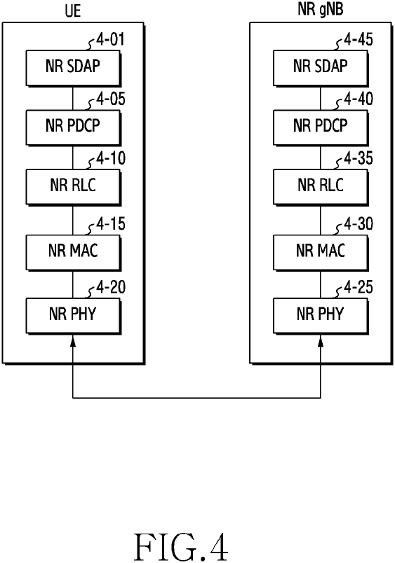

FIG. 4 illustrates a wireless protocol structure of the next-generation mobile communication system according to an embodiment of the present disclosure.

Referring to FIG. 4, the wireless protocol structure of the next-generation mobile communication system may include, in a terminal and an NR base station, an NR service data adaption protocol (SDAP) 4-01, 4-45, an NR PDCP 4-05, 4-40, an NR RLC 4-10, 4-35, an NR MAC 4-15, 4-30, and an NR PHY layer 4-20, 4-25, respectively. Of course, the wireless protocol of the next-generation mobile communication system may include more or fewer layers than those illustrated in FIG. 4.

According to an embodiment of the disclosure, primary functions of the NR SDAP 4-01, 4-45 may include some of the following functions. Of course, the present disclosure is not limited to the following examples:
-Transfer of user plane data;
-Mapping between a QoS flow and a DRB for both DL and UL;
-Marking QoS flow ID in both DL and UL packets; and/or
-Mapping reflective QoS flow to DRB for the UL SDAP PDUs.

With respect to the SDAP device (hereinafter, interchangeably used with a layer, a layer device) 4-01, 4-45, the terminal may receive a configuration on whether a header of the SDAP layer device may be used or whether a function of the SDAP device 4-01, 4-45 may be used, for each PDCP layer device, each bearer, or each logical channel, through a radio resource control (RRC) message. When the SDAP header is configured, the terminal may indicate updating or reconfiguring of mapping information for a QoS flow and a data bearer of uplink and downlink, by using a non-access stratum (NAS) QoS reflective configuration 1 bit indicator (NAS reflective QoS) of the SDAP header, and an access stratum (AS) QoS reflective configuration 1 bit indicator (AS reflective QoS). According to an embodiment, the SDAP header may include QoS flow ID information indicating QoS. In addition, according to an embodiment, QoS information may be used as a data processing priority, scheduling information for supporting a smooth service.

According to an embodiment of the present disclosure, primary functions of the NR PDCP 4-05, 4-40 may include some of the following functions. Of course, the present disclosure is not limited to the following examples:
-Header compression and decompression: ROHC only;
-Transfer of user data;
-In-sequence delivery of upper layer PDUs;
-Out-of-sequence delivery of upper layer PDUs;
-PDCP PDU reordering for reception);
-Duplicate detection of lower layer SDUs;
-Retransmission of PDCP SDUs;
-Ciphering and deciphering; and/or
-Timer-based SDU discard in uplink.

According to an embodiment of the disclosure, the reordering function of the NR PDCP device 4-05, 4-40 may refer to a function of reordering PDCP PDUs received from a lower layer, based on a PDCP sequence number (SN). The reordering function of the NR PDCP device 4-05, 4-40 may include at least one of a function of delivering data to a higher layer in a reordered sequence, a function of directly delivering without considering a sequence, a function of reordering and recording lost PDCP PDUs, a function of reporting states of the lost PDCP PDUs to a transmission side, and a function of requesting retransmission for the lost PDCP PDUs.

According to an embodiment of the disclosure, primary functions of the NR RLC 4-10, 4-35 may include some of the following functions. Of course, the disclosure is not limited to the following functions:
-Transfer of upper layer PDUs;
-In sequence delivery of upper layer PDUs;
-Out-of-sequence delivery of upper layer PDUs;
-Error correction through ARQ;
-Concatenation, segmentation and reassembly of RLC SDUs;
-Re-segmentation of RLC data PDUs;
-Reordering of RLC data PDUs;
-Duplicate detection;
-Protocol error detection;
-RLC SDU discard; and/or
-RLC re-establishment.

According to an embodiment of the disclosure, the in-sequence delivery function of the NR RLC device 4-10, 4-35 may refer to a function of delivering RLC SDUs received from a lower layer to an upper layer in sequence. In addition, the in-sequence delivery function of the NR RLC device 4-10, 4-35 may include a function of, when one RLC SDU is segmented into a plurality of RLC SDUs and is received, reassembling the RLC SDUs and delivering the same.

In addition, according to an embodiment of the disclosure, the in-sequence delivery function of the NR RLC device 4-10, 4-35 may include at least one of a function of reordering the received RLC PDUs with reference to an RLC SN or a PDCP SN, a function of reordering and recording lost RLC PDUs, a function of reporting states of the lost RLC PDUs to a transmission side, a function of requesting retransmission for the lost RLC PDUs.

According to an embodiment, the in-sequence delivery function of the NR RLC device 4-10, 4-35 may include at least one of a function of, when there is a lost RLC SDU, delivering only RLC SDUs before the lost RLC SDU to a higher layer in sequence, a function of, when a predetermined timer is expired, delivering all RLC SDUs received before the timer starts to a higher layer in sequence even if there is a lost RLC SDU, a function of, when the predetermined timer is expired, delivering all RLC SDUs received until a present time to a higher layer in sequence even if there is a lost RLC SDU.

According to an embodiment of the disclosure, the NR RLC device 4-10, 4-35 may process RLC PDUs in the order the RLC PDUs are received, regardless of the order of a sequence number (out-of-sequence delivery), and may deliver the RLC PDUs to the NR PDCP device.

According to an embodiment of the disclosure, when the NR RLC device 4-10, 4-35 receives segments, the NR RLC device 4-10, 4-35 may receive segments which have been stored in a buffer or may be received afterward, and reconstruct one complete RLC PDU, and then, may deliver the RLC PDU to the NR PDCP device.

According to an embodiment of the disclosure, the NR RLC device 4-10, 4-35 may not include a concatenation function, and this function may be performed in the NR MAC layer or may be substituted with a multiplexing function of the NR MAC layer.

In the above explanation, the out-of-sequence delivery function of the NR RLC device may refer to a function of delivering RLC SDUs received from a lower layer directly to a higher layer regardless of the sequence of the RLC SDUs. In addition, the out-of-sequence delivery function of the NR RLC device may include a function of, when one original RLC SDU is segmented into a plurality of RLC SDUs and the segmented RLC SDUs are received, reassembling the RLC SDUs and delivering the same. In addition, the out-of-sequence delivery function of the NR RLC device may include a function of storing the RLC SN or PDCP SN of received RLC PDUs, ordering, and recording lost RLC PDUs.

According to an embodiment, the NR MAC device 4-15, 4-30 may be connected with various NR RLC layer devices constructed in one terminal, and primary functions of the NR MAC 4-15, 4-30 may include some of the following functions. Of course, the present disclosure is not limited to the following examples:
-Mapping between logical channels and transport channels;
-Multiplexing/demultiplexing of MAC SDUs;
-Scheduling information reporting;
-Error correction through HARQ;
-Priority handling between logical channels of one UE;
-Priority handling between UEs by means of dynamic scheduling;
-MBMS service identification;
-Transport format selection; and/or
-Padding.

According to an embodiment of the disclosure, the NR PHY layer 4-20, 4-25 may perform an operation of channel coding and modulating upper layer data, making an OFDM symbol and transmitting via a wireless channel, or an operation of demodulating an OFDM symbol received through a wireless channel, channel decoding, and delivering to an upper layer. Of course, the disclosure is not limited to the above-described examples.

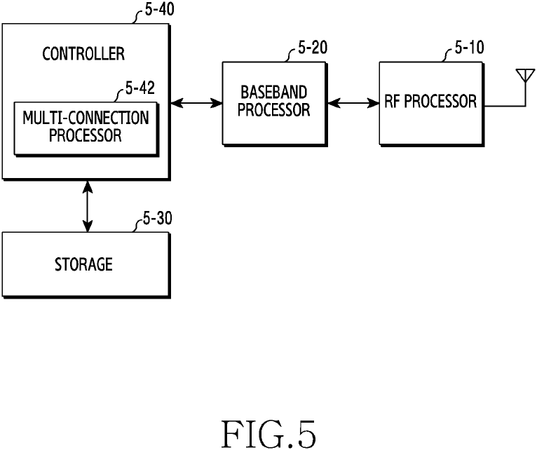

FIG. 5 illustrates an inner structure of a terminal according to an embodiment of the disclosure.

Referring to FIG. 5, the terminal may include a radio frequency (RF) processor 5-10, a baseband processor 5-20, a storage 5-30, and a controller 5-40. Of course, the disclosure is not limited to the above-described example, and the terminal may include fewer components than the components illustrated in FIG. 5, or may include more components.

The RF processor 5-10 may perform functions for transmitting and receiving signals via a wireless channel, such as band conversion and amplification of a signal. That is, the RF processor 5-10 may up-convert a baseband signal provided from the baseband processor 5-20 into an RF band signal, and then may transmit the signal via an antenna, and may down-convert an RF band signal received via the antenna into a baseband signal. For example, the RF processor 5-10 may include a transmission filter, a reception filter, an amplifier, a mixer, an oscillator, a digital to analogue converter (DAC), and an analog to digital converter (ADC). Although FIG. 5 illustrates only one antenna, the terminal may include a plurality of antennas.

In addition, the RF processor 5-10 may include a plurality of RF chains. Furthermore, the RF processor 5-10 may perform beamforming. For beamforming, the RF processor 5-10 may adjust a phase and a strength of each of signals transmitted and received through the plurality of antennas or antenna elements. In addition, the RF processor 5-10 may perform multiple input multiple output (MIMO), and may receive a plurality of layers when performing MIMO. The RF processor 5-10 may perform reception beam sweeping by appropriately configuring the plurality of antennas or antenna elements under the control of the controller 5-40, or may adjust the orientation and beam width of a reception beam such that the reception beam is coordinated with a transmission beam.

According to an embodiment of the disclosure, the baseband processor 5-20 may perform a function of converting between a baseband signal and a bit stream according to a physical layer standard of a system. For example, when transmitting data, the baseband processor 5-20 may generate complex symbols by encoding and modulating a transmission bit stream. In addition, when receiving data, the baseband processor 5-20 may restore a reception bit stream by demodulating and decoding a baseband signal provided from the RF processor 5-10.

For example, when transmitting data according to an orthogonal frequency division multiplexing (OFDM) method, the baseband processor 5-20 may generate complex symbols by encoding and modulating a transmission bit stream, may map the complex symbols onto subcarriers, and then, may construct OFDM symbols through inverse fast Fourier transform (IFFT) operation and cyclic prefix (CP) insertion. In addition, when receiving data, the baseband processor 5-20 may divide a baseband signal provided from the RF processor 5-10 in the unit of an OFDM symbol, may restore signals mapped onto subcarriers through fast Fourier transform (FFT) operation, and then, may restore a reception bit stream by demodulating and decoding.

According to an embodiment of the disclosure, the baseband processor 5-20 and the RF processor 5-10 may transmit and receive signals as described above. Accordingly, the baseband processor 5-20 and the RF processor 5-10 may be referred to as a “transmitter,” a “receiver,” a “transceiver,” or a “communication unit.” Furthermore, at least one of the baseband processor 5-20 and the RF processor 5-10 may include a plurality of communication modules to support a plurality of different radio access technologies. In addition, at least one of the baseband processor 5-20 and the RF processor 5-10 may include different communication modules to process signals of different frequency bands.

For example, the different radio access technologies may include a wireless local area network (LAN) (for example, IEEE 802.11), a cellular network (e.g., LTE), or the like. In addition, the different frequency bands may include a super high frequency (SHF) (for example, 2. NRHz, NRhz) band, a millimeter wave (for example, 60 GHz) band. The terminal may transmit and receive signals to and from a base station by using the baseband processor 5-20 and the RF processor 5-10.

The storage 5-30 may store data such as a basic program for operations of the terminal, an application program, configuration information. In particular, the storage 5-30 may store information related to a second access node performing wireless communication by using a second radio access technology. In addition, the storage 5-30 may provide stored data according to a request of the controller 5-40. In addition, the storage 5-30 may include a plurality of memories. According to an embodiment, the storage 5-30 may store a program for performing a method of transmitting terminal capability information for conditional PSCell change explained in the disclosure.

According to an embodiment of the disclosure, the controller 5-40 may control overall operations of the terminal. For example, the controller 5-40 may transmit and receive signals via the baseband processor 5-20 and the RF processor 5-10. In addition, the controller 5-40 may write and read out data on and from the storage 5-30. To achieve this, the controller 5-40 may include at least one processor. For example, the controller 5-40 may include a communication processor (CP) to perform control for communication, and an application processor (AP) to control a higher layer such as an application program. In addition, at least one configuration in the terminal may be implemented by one chip. In addition, according to an embodiment of the disclosure, the controller 5-40 may include a multi-connection processor 5-42 configured to perform processing for operating in a multi-connection mode.

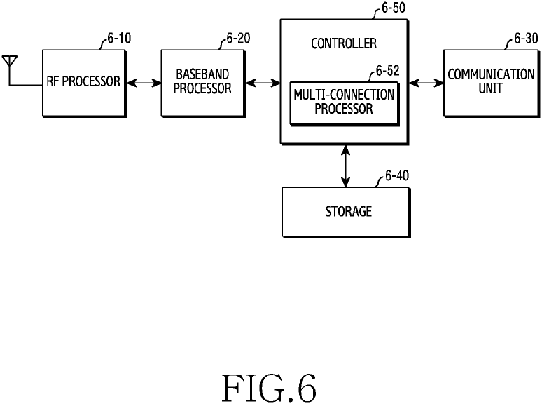

FIG. 6 illustrates a configuration of an NR base station according to an embodiment of the present disclosure.

As shown in FIG. 6, the base station may include an RF processor 6-10, a baseband processor 6-20, a backhaul communication unit 6-30, a storage 6-40, and a controller 6-50. Of course, the disclosure is not limited to the above-described example, and the base station may include fewer components than the components illustrated in FIG. 6, or may include more components.

According to an embodiment of the disclosure, the RF processor 6-10 may perform functions for transmitting and receiving signals via a wireless channel, such as band conversion and amplification of a signal. That is, the RF processor 6-10 may up-convert a baseband signal provided from the baseband processor 6-20 into an RF band signal, and then may transmit the signal via an antenna, and may down-convert an RF band signal received via the antenna into a baseband signal. For example, the RF processor 6-10 may include a transmission filter, a reception filter, an amplifier, a mixer, an oscillator, a DAC, and an ADC. Although FIG. 6 illustrates only one antenna, the base station may include a plurality of antennas. In addition, the RF processor 6-10 may include a plurality of RF chains. Furthermore, the RF processor 6-10 may perform beamforming. For beamforming, the RF processor 6-10 may adjust a phase and a strength of each of signals transmitted and received through the plurality of antennas or antenna elements. In addition, the RF processor may perform downward MIMO by transmitting one or more layers.

According to an embodiment of the disclosure, the baseband processor 6-20 may perform a function of converting between a baseband signal and a bit stream according to a physical layer standard of a first radio access technology. For example, when transmitting data, the baseband processor 6-20 may generate complex symbols by encoding and modulating a transmission bit stream. When receiving data, the baseband processor 6-20 may restore a reception bit stream by demodulating and decoding a baseband signal provided from the RF processor 6-10. For example, when transmitting data according to an OFDM method, the baseband processor 6-20 may generate complex symbols by encoding and modulating a transmission bit stream, may map the complex symbols onto subcarriers, and then, may construct OFDM symbols through IFFT operation and CP insertion.

In addition, when receiving data, the baseband processor 6-20 may divide a baseband signal provided from the RF processor 6-10 in the unit of an OFDM symbol, may restore signals mapped onto subcarriers through FFT operation, and then, may restore a reception bit stream by demodulating and decoding. The baseband processor 6-20 and the RF processor 6-10 may transmit and receive signals as described above. Accordingly, the baseband processor 6-20 and the RF processor 6-10 may be referred to as a “transmitter,” a “receiver,” a “transceiver,” a “communication unit,” or a wireless communication unit.”

According to an embodiment of the disclosure, the communication unit 6-30 may provide an interface for communicating with other nodes in a network. That is, the communication unit 6-30 may convert a bit stream to be transmitted from a main base station to another node, for example, a sub-base station, a core network, into a physical signal, and may convert a physical signal transmitted from another node into a bit stream.

The storage 6-40 may store data such as a basic program for operations of the main base station, an application program, and configuration information. In particular, the storage 6-40 may store information regarding a bearer assigned to a connected terminal, a result of measurement reported by a connected terminal. In addition, the storage 6-40 may store information as a criterion for determining whether to provide or stop multi-connection to a terminal. In addition, the storage 6-40 may provide stored data according to a request of the controller 6-50. The storage 6-40 may be constructed by a storage medium, such as a read only memory (ROM), a random access memory (RAM), a hard disk, a compact disk (CD)-ROM, and a digital versatile disk (DVD), or a combination of the storage media. In addition, the storage 6-40 may include a plurality of memories. According to an embodiment, the storage 6-40 may store a program for performing a method of transmitting terminal capability information for conditional PSCell change explained in the disclosure.

The controller 6-50 may control overall operations of the base station. For example, the controller 6-50 may transmit and receive signals via the baseband processor 6-20 and the RF processor 6-10 or the backhaul communication unit 6-30. In addition, the controller 6-50 may write and read out data on and from the storage 6-40. To achieve this, the controller 6-50 may include at least one processor. In addition, at least one configuration of the base station may be implemented by one chip. In addition, the respective configurations of the base station may operate to perform the above-described embodiments of the disclosure.

Currently, conditional PSCell addition and change (CPAC) may include three types of operations. For example, CPAC may include conditional PSCell addition (CPA), MN-initiated conditional PSCell change (MI-CPC), SN-initiated CPC (SI-CPC). Of course, the disclosure is not limited to the above-described examples.

A node starting a procedure may be different according to a type of CPAC. In CPA and MI-CPC, an MN initiates a procedure, and in SI-CPC, an SN initiates a procedure.

According to an embodiment of the disclosure, when a conditional reconfiguration, that is, specific CPC, is performed, configuration information which is usable in a candidate target cell, and conditional information for performing CPC may require a capability for storing the configuration information usable in the candidate target cell of the terminal, and the conditional information for performing CPC, and a measurement capability for determining conditional information.

The capability for storing of the terminal and the measurement capability for determining the conditional information may be defined in the unit of the number of candidate target cells. That is, the terminal may perform conditional reconfiguration with respect to a predetermined number of candidate target cells.

However, as described above, a node starting(initiating) first according to a type of CPAC may have authority to define a maximum number of conditional reconfigurations in each procedure. Accordingly, when a capability related to the number of conditional reconfigurations for each terminal is determined, there may be a need for negotiation on the number of conditional reconfigurations between the MN or SN regarding a procedure that the MN or SN initiates. The following is a procedure initiating node when conditional handover (CHO) and Rel-16 intra-SN CPC are also considered:
An initiating node:
-CPA: MN
-MI-CPC: MN
-SI-CPC: SN
-CHO: MN; and/or
-Intra-SN CPC: SN

According to how the capability of conditional reconfiguration of the terminal is defined, the maximum number of conditional reconfigurations operated by the MN or SN per type (including CPAC, CHO, Rel-16 CPC) may be different, and the number of conditional reconfiguration for each procedure of the MN or SN may be different (In the following embodiments, not only CPAC but also CHO and R16 intra-SN CPC are considered in conditional reconfiguration).

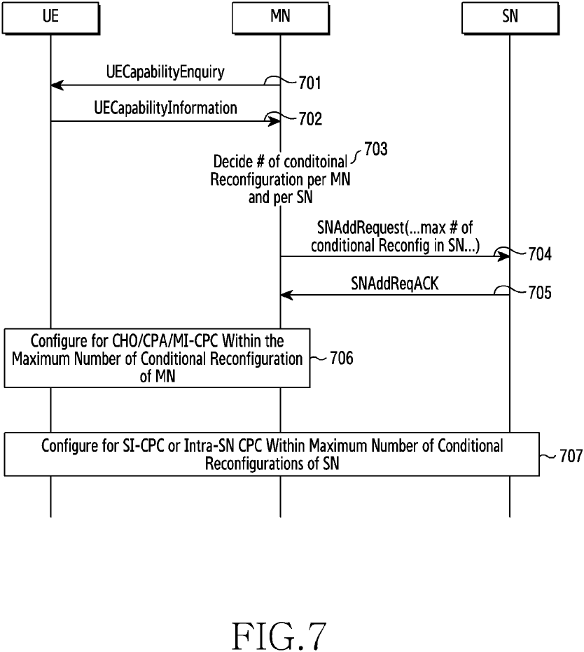

FIG. 7 illustrates an inter-node signal system in which a master node (MN) receiving UE capability information from UE delivers information, to a secondary node (SN), regarding a maximum number of conditional reconfigurations allowed to the SN according to an embodiment of the present disclosure.

All of the following embodiments may be applied to capability signaling of FIG. 7. The MN and the SN in FIG. 7 may be all base stations. That is, the MN may be a first base station and the SN may be a second base station. Of course, the disclosure is not limited to the above-described examples.

In a first embodiment, capability information of the terminal may include a maximum number of conditional reconfigurations for each terminal (e.g., unified one).

At step 701, the MN may request UE capability information from the terminal. For example, the MN may request the UE capability information from the terminal through a UECapabilityEnquiry message or a message corresponding thereto, and the type of a message is not limited to the above-described examples.

At step 702, the MN may receive the UE capability information including the maximum number of conditional reconfigurations for each terminal from the terminal. A message through which the terminal provides the UE capability information may be UECapabilityInformation or an RRC message corresponding thereto. Of course, the type of a message is not limited to the above-described examples.

At step 703, the MN which receives the UECapabilityInformation message may determine a maximum number of conditional reconfigurations for MN and SN. In addition, according to an embodiment of the disclosure, the MN may determine the maximum number of conditional reconfigurations for MN and for SN, based on the maximum number of conditional reconfigurations for each terminal. In addition, according to an embodiment of the disclosure, the MN may determine a maximum number of conditional reconfigurations for CHO, MI-CPC, CPA of the MN.

At step 706, the MN may perform configuration for CHO, MI-CPC, CPA within the maximum number of conditional reconfigurations of the MN.

In addition, at step 704, the MN may determine a maximum number of conditional reconfigurations operable by the SN (that is, intra-SN CPC), and may inform the SN of this.

At step 705, the SN may respond to the maximum number of conditional reconfigurations which is informed by the MN. The SN may accept or negotiate about the maximum number of conditional reconfigurations informed by the MN. The negotiation will be described in detail below.

At step 707, the SN may perform SI-CP or intra-SN CPC configuration within the maximum number of conditional reconfigurations.

The SN may not always accept the maximum number of conditional configurations which is informed by the MN, and may negotiate with the MN about the number of conditional reconfigurations. The following method may be considered as signaling for negotiation on the maximum number of conditional reconfigurations between the MN and the SN. Of course, the disclosure is not limited to the above-described examples.

In one example (Opt 1-1), at step 704, when the MN receives the UE capability information from the terminal, the MN may determine the maximum number of conditional configuration to be allowed to the SN, and may inform a maximum number of conditional reconfigurations operable at the SN when SN addition is performed. The SN may establish conditional reconfigurations for the terminal within the maximum number of conditional reconfigurations operable at the SN, which is informed by the MN. Information on the maximum number of conditional reconfigurations operable at the SN may be included in an Xn field or RRC container field in an SNADDRequest message. Of course, the types of a message and a field are not limited to the above-described examples.

In one example (Opt 1-2),when it is necessary to change the maximum number of conditional reconfigurations operable at the SN, informed by the MN, according to Opt 1-1 described above, the SN may request a maximum number of conditional reconfigurations determined by the SN from the MN. The MN which receives a message requesting the predetermined maximum number of conditional reconfigurations may accept or refuse the request from the SN. In addition, the MN may deliver the message requesting the predetermined maximum number of conditional reconfigurations back to the SN. When the SN requests the maximum number of conditional reconfigurations determined by the SN from the MN, an SNModRequired message may be used. Of course, the type of a message is not limited to the above-described example. In addition, information that is used for the SN to request the predetermined maximum number of conditional reconfigurations may be included in an Xn field or RRC container field. Of course, the type of a field is not limited to the above-described example.

Opt 1-1 and Opt 1-2 described above may be supported all together. In the following embodiments, Opt 1-1 and Opt 1-2 may support a method in which the MN informs the SN of a maximum number of conditional reconfigurations for the SN, and as at step 705, the SN accepts or acknowledges or requests a desired maximum number of conditional reconfigurations from the MN to negotiate, and receives reconfirmation.

The information that is transmitted to the SN in Opt 1-1, Opt 1-2 described above may be expressed by the maximum number of conditional reconfigurations operable at the SN or a maximum number of CPC configurations (or a maximum number of candidate target PSCells for CPC). Of course, the disclosure is not limited to the above-described examples.

In a second embodiment, capability information of the terminal may include a maximum number of conditional reconfigurations for MN and for SN.

At step 701, the MN may request UE capability information from the terminal. For example, the MN may request the UE capability information from the terminal through a UECapabilityEnquiry message or a message corresponding thereto, and the type of a message is not limited to the above-described examples.

At step 702, the MN may receive the UE capability information including the maximum number of conditional reconfigurations for MN and for SN.

At step 703, the MN which receives the UECapabilityInformation message may determine a maximum number of conditional reconfigurations for MN and for SN. That is, the MN may identify the maximum number of conditional reconfigurations for MN and for SN, based on the capability information of the terminal. The MN may determine a number of conditional reconfigurations for CHO, MI-CPC, CPA operated by the MN.

At step 706, the MN may perform configuration for CHO, MI-CPC, CPA within the maximum number of conditional reconfigurations of the MN.

In addition, at step 704, the MN may determine (or identify) a maximum number of conditional reconfigurations of the SN, and may deliver information on the maximum number of conditional reconfigurations for SN to the SN. Step 705 corresponds to that described in the first embodiment, and a description thereof is omitted.

According to an embodiment of the disclosure, the SN may establish (or determine) conditional reconfigurations within the maximum number of conditional reconfigurations (SN initiated out of intra-SN CPC and inter-SN CPC).

At step 707, the SN may perform SI-CP or intra-SN CPC configuration within the maximum number of conditional reconfigurations of the SN.

In addition, in the second embodiment, both Opt 1-1 and Opt 1-2 described above may be applied as negotiation signaling between the MN and the SN. That is, the second embodiment may also support a method in which the MN informs the SN of a maximum number of conditional reconfigurations for the SN, and the SN accepts or acknowledges or requests a desired maximum number of conditional reconfigurations from the MN, and receives reconfirmation.

In a third embodiment, capability information of the terminal may include a maximum number of conditional reconfigurations of CPAC, and the capability information of the terminal may additionally include a maximum number of conditional reconfigurations of CHO and/or intra-SN CPC. According to an embodiment of the disclosure, the capability information of the terminal may include only capability information of CPAC (or additionally capability information of CHO and/or intra-SN CPC) without distinguishing between the MN and the SN.

At step 701, the MN may request UE capability information from the terminal. For example, the MN may request the UE capability information from the terminal through a UECapabilityEnquiry message or a message corresponding thereto, and the type of a message is not limited to the above-described examples.

At step 702, the MN may receive the UE capability information including a maximum number of conditional reconfigurations of CPAC from the terminal.

At step 703, the MN may determine a maximum number of conditional reconfigurations of the MN and the SN. That is, the MN may determine a number of conditional reconfigurations for CPA and MI-CPC among the maximum number of conditional reconfigurations of the CPAC (may additionally determine a number of conditional reconfigurations for CHO), and may negotiate with the SN about a number of conditional reconfigurations for SI-CPC (additionally a number of conditional reconfigurations for intra-SN CPC), except for the number of conditional reconfigurations for CPA and MI-CPC. Opt 1-1/1-2 of the first embodiment may be applied as signaling between the MN and the SN. The SN may perform SI-CPC configuration within the maximum number on which the SN negotiates with the MN.

At step 706, the MN may perform CPA, MI-CP configuration according to the determined number, and may additionally perform CHO configuration.

At step 707, the SN may perform SI-CPC configuration or intra-SN CPC configuration according to the determined number.

In a fourth embodiment, capability information of the terminal may include a maximum number of conditional reconfigurations of CHO and/or CPA and/or MI-CPC and/or SI-CPC and/or intra-SN CPC.

At step 701, the MN may request the UE capability information from the terminal. For example, the MN may request the UE capability information from the terminal through a UECapbilityEnquiry message or a message corresponding thereto, and the type of a message is not limited to the above-described example.

At step 702, if the MN receives the UE capability information including a maximum number of conditional reconfigurations of CHO and/or CPA and/or MI-CPC and/or SI-CPC and/or intra-SN CPC, the MN may perform configuration within the given maximum number of conditional reconfigurations when performing CPA, MI-CPC and CHO. In addition, the MN delivers information on the maximum number of conditional reconfigurations for SI-CPC and intra-SN CPC to the SN. In this case, the SN may not be able to negotiate with the MN. Since SI-CPC capability information has been determined at the terminal, the SN may not be able to transmit a request for the number for negotiation to the MN.

Other embodiments of the disclosure provide a method for determining whether CPC may be performed in a deactivation state of a secondary cell group (SCG). The SCG deactivation state will be described below:
-Only the MN may include the indication of SCG deactivation in RRCReconfig of an MN format;
-In SCG deactivation, the SCG still performs radio resource management (RRM), radio link monitoring (RLM) and/or beam failure detection (BFD);
-As a result of RRM, the UE may report a measurement result (MR) to the SN via MN’s link, and may get the other RRC message such as PSCell change, addition, including MN’s HO, idle/inactive state change;
-Random access (RA) is done only when it is configured to be done; and/or
PSCell change during SCG deactivation may be just reconfiguration with the received one and RA to the target PSCell may not be performed if not configured.

If CPC is allowed or not allowed in the SCG deactivation state, different terminal operations from the above-described operations of the terminal may be required.

First, a method for preventing CPC execution if CPC is not allowed will be described. The disclosure is not limited to the following example.

### Opt 1-1: Stopping CPC Condition Evaluation Upon SCG Deactivation

### Operation

1. CPC configuration is included in RRCReconfiguration, and RRCReconfiguration is given to the terminal in the deactivated SCG (case 1), or RRCReconfiguraiton including CPC configuration and SCG activation indication may be given to the activated terminal (case 2).

2. Upon receiving the RRCReconfiguraiton message, the UE stores CPC configuration, and starts the measurement related to the execution condition.

3. The UE stops the evaluation of the CPC execution condition when the RRCReconfiguraiton message is received and is applied, that is, when the SCG is deactivated (case 1) or is about to be deactivated. The case in which the SCG is about to be deactivated may include a case in which the terminal is in an SCG activation state but a deactivation indication is delivered in one RRCReconfiguration along with the CPC configuration.

4. The UE resumes the evaluation of the CPC execution condition when the SCG is activated again.

The reason why the above-described method is feasible is that the RRM/RLM/BFD is still running on the deactivated SCG. The RRM MR is transmitted via an MCG RRC message. Since the condition evaluation and the CPC execution are associated with the RRM, the UE needs to explicitly stop the evaluation of the CPC execution condition.

### Opt 1-2: Stopping the Measurement Related to the CPC Execution Condition Upon SCG Deactivation

### Operation

1. CPC configuration is included in RRCReconfiguration, and RRCReconfiguration is given to the terminal in the deactivated SCG (case 1), or RRCReconfiguraiton including CPC configuration and SCG activation indication may be given to the activated terminal (case 2).

2. Upon receiving the RRCReconfiguraiton message, the UE stores CPC configuration.

3. The UE does not start the measurement of which measId is only associated to any CPC execution condition received or stored among received or stored measurement configurations (corresponding the case 1). If there already has been started measurement before the CPC reception, and the started measurement is only related to the CPC execution condition and not related to the normal measurement, the UE stops those on-going measurement, and/or if the measurement is related to the CPC execution condition included in a newly received RRCReconfiguration message and is not related to the other normal measurement, the UE does not start the ongoing measurement (corresponding to the case 2).

4. The measurement which were “not started due to deactivated SCG” or “stopped due to the deactivated SCG” is resumed and the related CPC execution condition evaluation is started upon SCG activated.

In performing the above-described operations, a message that the terminal receives may include the following configurations:

In one example (Opt 1), when the terminal receives a deactivation command, the network includes, in the RRCReconfiguration including SCG deactivation, the release of measId in the measConfig which is related only to the CPC execution condition. The terminal which receives this command may stop the measurement on the corresponding measId.

When the terminal receives an activation command again, the RRCReconfiguration including the activation command also may include that original measId again. The terminal which receives this command may perform the measurement corresponding to the measId given again.

In one example, (Opt 2),this operation is a method of introducing a separate terminal variable and storing information regarding measurement that may be temporarily stopped due to deactivation.

When the terminal performs CPC-related measurement or receives CPC configuration on RRCReconfiguraiton even if the CPC-related measurement is not performed, and there exists an SCG deactivation indication in the RRCReconfiguration message, the UE may remove measId (and/or the component MO, reportConfig) which is only related to any CPC execution condition from VarMeasConfig, and may add those to the new temporal measId variable. In addition, the measurement corresponding to measId which is removed from VarMeasConfig may not be performed or may be stopped.

Upon receiving an SCG activation command (i.e., RRCReconfiguration including an SCG activation indication) and there is no change on CPC configurations regarding those CPC execution condition measId, the corresponding measId configurations may be reverted back to the VarMeasConfig, and the measurement on those measID may be started and evaluation of the execution condition on those measId may be started.

In one example (Opt 1-3), upon SCG deactivation, the MN may release all the CPC configurations (within the same RRCReconfiguration message).

In one example (Opt 1-4), upon SCG deactivation, the UE may autonomously release all the CPC configurations in current VarConditionalReconfiguration.

Next, when CPC performance of the terminal is accepted, the terminal may perform the following operations, which is different from existing deactivated SCG operations.

When a specific CPC condition is satisfied in the SCG deactivated state, the terminal may perform PSCell change to a selected target PSCell. In this case, the terminal may perform random access to the corresponding PSCell, and may transmit a RRCReconfigurationComplete message to the corresponding PSCell. In this case, the terminal may convert the SCG state to an autonomously activation state.

Embodiments disclosed herein provide an apparatus and a method for effectively providing a service in a mobile communication system.

Methods based on the claims or the embodiments disclosed in the disclosure may be implemented in hardware, software, or a combination of both.

When implemented in software, a computer readable storage medium for storing one or more programs (software modules) may be provided. The one or more programs stored in the computer readable storage medium are configured for execution performed by one or more processors in an electronic device. The one or more programs include instructions for allowing the electronic device to execute the methods based on the claims or the embodiments disclosed in the disclosure.

The program (the software module or software) may be stored in a random access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs) or other forms of optical storage devices, and a magnetic cassette. Alternatively, the program may be stored in a memory configured in combination of all or some of these storage media. In addition, the configured memory may be plural in number.

Further, the program may be stored in an attachable storage device capable of accessing the electronic device through a communication network such as the Internet, an Intranet, a local area network (LAN), a wide LAN (WLAN), or a storage area network (SAN) or a communication network configured by combining the networks. The storage device may access via an external port to a device which performs the embodiments of the disclosure. In addition, an additional storage device on a communication network may access to a device which performs the embodiments of the disclosure.

In the above-described specific embodiments of the disclosure, elements included in the disclosure are expressed in singular or plural forms according to specific embodiments. However, singular or plural forms are appropriately selected according to suggested situations for convenience of explanation, and the disclosure is not limited to a single element or plural elements. An element which is expressed in a plural form may be configured in a singular form or an element which is expressed in a singular form may be configured in plural number.

Embodiments of the disclosure disclosed in the specification and the drawings provide specific examples for easy explanation of the technical features of the disclosure and for easy understanding of the disclosure, and do not limit the scope of the disclosure. That is, it is obvious to a person skilled in the art that other variations based on the technical concept of the disclosure are possible. In addition, the above-described embodiments may be operated in combination when necessary. For example, the base station and the terminal may operate in combination of an embodiment of the disclosure and some of other embodiments. In addition, embodiments of the disclosure may be applicable to other communication systems, and other variations based on the technical concept of the embodiments are also possible.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first base station in a wireless communication system, the method comprising:
transmitting, to a second base station, a secondary node addition request message including information for a number of conditional reconfigurations allowed to the second base station; and
receiving, from the second base station, a secondary node addition request acknowledge message in response to transmitting the secondary node addition request message,
wherein the information for the number of conditional reconfigurations is used to provide configuration information for a condition reconfiguration between a user equipment (UE) and the second base station.

2. The method of claim 1, wherein the information for the number of conditional reconfigurations includes information for a number of conditional reconfigurations for a secondary node initiated conditional primary secondary cell (PSCell) change (SI-CPC).

3. The method of claim 1, wherein the information for the number of conditional reconfigurations is included in a radio resource control (RRC) container of the secondary node addition request message.

4. The method of claim 1, further comprising:
transmitting, to the UE, a UE capability enquiry message; and
receiving, from the UE, a UE capability information message including capability information of the UE related to a conditional reconfiguration in response to transmitting the UE capability enquiry message.

5. The method of claim 1, further comprising:
transmitting, to the UE, a radio resource control (RRC) reconfiguration message to configure at least one conditional reconfiguration,
wherein each of the at least one conditional reconfiguration is used for at least one of a conditional handover, a conditional primary secondary cell (PSCell) change (CPC), or a conditional PSCell addition (CPA).

6. A method performed by a second base station in a wireless communication system, the method comprising:
receiving, from a first base station, a secondary node addition request message including information for a number of conditional reconfigurations allowed to the second base station;
transmitting, to the first base station, a secondary node addition request acknowledge message in response to receiving the secondary node addition request message; and
performing a configuration procedure with a user equipment (UE) based on the number of conditional reconfigurations allowed to the second base station.

7. The method of claim 6, wherein the information for the number of conditional reconfigurations includes information for a number of conditional reconfigurations for a secondary node initiated conditional primary secondary cell (PSCell) change (SI-CPC).

8. The method of claim 6, wherein the information for the number of conditional reconfigurations is included in a radio resource control (RRC) container of the secondary node addition request message.

9. The method of claim 6, wherein performing the configuration procedure with the UE comprises:
transmitting, to the UE, a radio resource control (RRC) reconfiguration message to configure at least one conditional reconfiguration.

10. The method of claim 9, wherein each of at least one conditional reconfiguration is used for at least one of a conditional handover, a conditional primary secondary cell (PSCell) change (CPC), or a conditional PSCell addition (CPA).

11. A first base station in a wireless communication system, the first base station comprising:
at least one transceiver; and
at least one processor operatively coupled with the at least one transceiver, wherein the at least one processor is configured to:
transmit, to a second base station, a secondary node addition request message including information for a number of conditional reconfigurations allowed to the second base station, and
receive, from the second base station, a secondary node addition request acknowledge message in response to transmitting the secondary node addition request message,
wherein the information for the number of conditional reconfigurations is used to provide configuration information for a condition reconfiguration between a user equipment (UE) and the second base station.

12. The first base station of claim 11, wherein the information for the number of conditional reconfigurations includes information for a number of conditional reconfigurations for a secondary node initiated conditional primary secondary cell (PSCell) change (SI-CPC).

13. The first base station of claim 11, wherein the information for the number of conditional reconfigurations is included in a radio resource control (RRC) container of the secondary node addition request message.

14. The first base station of claim 11, wherein the at least one processor is further configured to:
transmit, to the UE, a UE capability enquiry message; and
receive, from the UE, a UE capability information message including capability information of the UE related to a conditional reconfiguration in response to transmitting the UE capability enquiry message.

15. The first base station of claim 11, wherein the at least one processor is further configured to:
transmit, to the UE, a radio resource control (RRC) reconfiguration message to configure at least one conditional reconfiguration,
wherein each of the at least one conditional reconfiguration is used for at least one of a conditional handover, a conditional primary secondary cell (PSCell) change (CPC), or a conditional PSCell addition (CPA).

16. A second base station in a wireless communication system, the second base station comprising:
at least one transceiver; and
at least one processor operatively coupled with the at least one transceiver, wherein the at least one processor is configured to:
receive, from a first base station, a secondary node addition request message including information for a number of conditional reconfigurations allowed to the second base station;
transmit, to the first base station, a secondary node addition request acknowledge message in response to receiving the secondary node addition request message; and
perform a configuration procedure with a user equipment (UE) based on the number of conditional reconfigurations allowed to the second base station.

17. The second base station of claim 16, wherein the information for the number of conditional reconfigurations includes information for a number of conditional reconfigurations for a secondary node initiated conditional primary secondary cell (PSCell) change (SI-CPC).

18. The second base station of claim 16, wherein the information for the number of conditional reconfigurations is included in a radio resource control (RRC) container of the secondary node addition request message.

19. The second base station of claim 16, wherein the at least one processor is further configured to:
transmit, to the UE, a radio resource control (RRC) reconfiguration message to configure at least one conditional reconfiguration.

20. The second base station of claim 19, wherein each of at least one conditional reconfiguration is used for at least one of a conditional handover, a conditional primary secondary cell (PSCell) change (CPC), or a conditional PSCell addition (CPA).
